(19) United States
(12) Patent Application Publication
(10) Pub. No.: US 2011/0105695 A1
(43) Pub. Date: May 5, 2011

(54) Method for making Plas stereocomplexes

(76) Inventors: Joseph D. Schroeder, Minneapolis, MN (US); Robert Thomas Kean, Minneapolis, MN (US)

(21) Appl. No.: 12/679,376

(22) PCT Filed: Sep. 26, 2008
(86) PCT No.: PCT/US08/77806

§ 371 Date: Dec. 27, 2010

Related U.S. Application Data
(60) Provisional application No. 60/995,844, filed on Sep. 28, 2007.

(51) Int. Cl. C08G 63/91

(52) U.S. Cl. 525/411; 525/415

(57) ABSTRACT

PLA stereocomplexes are formed from poly-D-PLA and poly-L-PLA oligomers. The oligomers contain functional groups which allow them to react with each other or with an added curing agent to produce a high molecular weight block copolymer. Heat treatment of the resin permits the resin to develop crystallites having a melting temperature of 185° C. or more.

This application claims benefit of U.S. Provisional Patent Application No. 60/995,844, filed 28 Sep. 2007.

This invention relates to methods for forming stereocomplexes of PLA resins. Polylactide resins (also known as polylactic acid, or PLA), are now available commercially. These resins can be produced from annually renewable resources such as corn, rice or other sugar- or starch-producing plants. In addition, PLA resins are compostable. For these reasons, there is significant interest in substituting PLA into applications in which oil-based thermoplastic materials have conventionally been used. To this end, PLA has been implemented into various applications such as fibers for woven and nonwoven applications, containers such as water bottles, and a variety of thermoformed articles such as deli trays, cups, and other food packaging applications.

A problem with PLA resins is that they usually have low resistance to heat. PLA resins generally exhibit a glass transition temperature (T_{g}) in the range from 60 to 66° C. PLA articles tend to become distorted when exposed to temperatures above the T_{g}. This makes PLA resins generally less suitable for applications in which they are exposed to temperatures greater than about 60° C.

One approach to improving the thermal properties of PLA resins is to form high-melting crystallites. Mixtures of high-D and high-L PLA resins are known to form a crystalline structure that is known as a “stereocomplex”. The stereocomplex exhibits a crystalline melting temperature as much as 60° C. higher than that of the high D- or high L-resin by itself. In principle, the heat resistance of a PLA article can be increased quite significantly if these stereocomplex crystallites are present in sufficient quantities.

The reality is that no methods have been developed by which stereocomplex-containing PLA articles can be produced rapidly and economically. For this reason, there have been no commercial applications for these materials despite the fact that these materials and their thermal characteristics have been known since at least the late 1980's.

The main obstacles to the commercial development of stereocomplexes are their high melting temperatures and the slow rate at which the stereocomplex crystals form. PLA resins tend to degrade rapidly at temperatures needed to melt the stereocomplex crystallites. This makes it difficult to melt-process the materials. As a result, research scale methods typically form the stereocomplex from solution so that lower temperatures can be used and less polymer degradation is seen. This is an unsatisfactory approach from the standpoint of commercial production, as the use of solvents increases costs, adds much complexity to the process, and raises concerns about worker exposure to volatile organic materials. Melt processing methods are needed to make stereocomplex parts economically on a large scale.

Melt processing of PLA stereocomplexes is also hampered because the resins tend to form stereocomplex crystals rather slowly. The slow rate of stereocomplex crystallite formation adds to the processing time, thereby lowering production rates and increasing costs.

JP 2002-356543 describes an approach for making PLA stereocomplexes, in which separate polymers are prepared, from D-lactide and L-lactide, respectively. These polymers are coupled to form a high (>100,000 Mw) molecular weight block copolymer that contains segments of poly-D-lactide and segments of poly-L-lactide. The individual segments have molecular weights of 5000 or more. This approach is said to increase the speed of stereocomplex crystallization, but requires high processing temperatures which can lead to molecular weight degradation.

In WO 2008/057214, separate poly-L-lactide and poly-D-lactide resins are blended and heated to above their respective melting temperatures in the presence of a transesterification catalyst. This process is believed to cause interesterification reactions to occur between the two polymers, resulting in the formation of block copolymers having poly-L-lactide segments and poly-D-lactide segments. The poly-L-lactide segments and the poly-D-lactide segments are connected by direct bonds between adjacent lactide units, i.e. between the terminal lactide units at the ends of the respective segments. This polymer is formed into sheet and thermoformed. The formation of the block copolymer in this manner increases stereocomplex crystallization rates in thermoforming processes. However, the length of the poly-D-lactide segments and the poly-L-lactide segments can be quite random in this approach. In addition, careful control over heating conditions must be exercised, or the poly-D-lactide segments and the poly-L-lactide segments may become too short to form the stereocomplex. There remains a need to develop methods by which PLA stereocomplexes can be prepared in a variety of commercially viable processes.

In one aspect, this invention is a block copolymer having a number average molecular weight of at least 25,000, the block copolymer having multiple segments of a poly-D-PLA, each having a segment weight of from 350 to 4800, and multiple segments of a poly-L-PLA, each having a segment weight of from 350 to 4800, wherein the poly-D-PLA segments and the poly-L-PLA segments are present in a weight ratio of from 20:80 to 80:20 and are linked through linking groups other than direct bonds between adjacent lactic acid units. In certain embodiments, the block copolymer contains at least 10, at least 20, at least 30 or at least 40 J/g of crystallites having a melting temperature of at least 185° C.

The invention is in another respect a process for making a high molecular weight block copolymer, comprising

I. forming a mixture of

a) a hydroxyl-, primary amine- or secondary amine-terminated PLA oligomer having at least one segment of repeating lactic acid units that has a weight of from 350 to 4800 daltons and which constitutes at least 60 weight percent of the oligomer and

b) a capped PLA oligomer having terminal coreactive groups and having at least one segment of repeating lactic acid units that has a weight of from 350 to 4800 daltons and which constitutes at least 60 weight percent of the oligomer; wherein the segment or segments of repeating lactic acid units in one of the PLA oligomers is a poly-D-PLA segment and the segment or segments of repeating lactic acid units in the other PLA oligomer, is a poly-L-PLA segment, and

II. curing the mixture to form a high molecular weight block copolymer having multiple segments of a poly-D-PLA that each has a weight of from 350 to 4800 daltons and multiple segments of a poly-L-PLA that each has a weight of from 350 to 4800 daltons.

A “coreactive group”, for purposes of this invention, means a group that reacts with a hydroxyl, primary amino or secondary amino group to form a covalent bond to the hydroxyloxygen or the amino nitrogen atom, as the case may be. A preferred type of coreactive group is an isocyanate group.

A preferred process further comprises:

III. heat treating the high molecular weight block copolymer at a temperature between its glass transition temperature and about 180° C. to form at least 10 J/g of crystallites having a melting temperature of at least 185° C.

The invention is in another respect a process for making a high molecular weight block copolymer, comprising

I. forming a mixture of

a) a hydroxyl-, primary amine- or secondary amine-terminated poly-D-PLA oligomer having at least one poly-D-PLA segment that has a weight of from 350 to 4800 daltons and which constitutes at least 60 weight percent of the poly-D-PLA oligomer,

b) a hydroxyl-, primary amine- or secondary amine-terminated poly-L-PLA oligomer having at least one poly-L-PLA segment that has a weight of from 350 to 4800 daltons and which constitutes at least 60 weight percent of the poly-L-PLA oligomer and

c) at least one curing agent that contains at least two coreactive groups per molecule, and,

II. curing the mixture to form a high molecular weight block copolymer. A preferred process further comprises:
III. heat treating the high molecular weight block copolymer at a temperature above its glass transition temperature to about 180° C. to form at least 10 J/g of crystallites having a melting temperature of at least 185° C. A preferred type of curing agent is a polyisocyanate, especially a diisocyanate.

The invention is in another respect a process for making a high molecular weight block copolymer, comprising

I. forming a mixture of

a) a poly-D-PLA oligomer which is terminated with coreactive groups and has at least one poly-D-PLA segment that has a weight of from 350 to 4800 daltons and which constitutes at least 60% by weight of the poly-D-PLA oligomer and,

b) a poly-L-PLA oligomer which is terminated with coreactive groups having at least one poly-L-PLA segment that has a weight of from 350 to 4800 daltons and which constitutes at least 60% by weight of the poly-L-PLA oligomer, and

c) at least one curing agent that contains at least two hydroxyl, primary amino or secondary amino groups per molecule, and

II. curing the mixture to form a high molecular weight block copolymer. The coreactive groups on the oligomers are preferably isocyanate groups. A preferred process further comprises:
III. heat treating the high molecular weight block copolymer at a temperature above its glass transition temperature to about 180° C. to form at least 10 J/g of crystallites having a melting temperature of at least 185° C.

This invention is also a capped, linear PLA resin having terminal coreactive groups and at least one poly-D-PLA or poly-L-PLA segment that has a weight of from 350 to 4800 daltons.

The invention in its various aspects provides methods by which PLA stereocomplex articles can be made easily and efficiently. An advantage of the process is that high processing temperatures often can be avoided. This can reduce the thermal degradation of the polymer that is often seen when PLA stereocomplexes are formed. The polymers tend to crystallize rapidly when subjected to crystallization conditions. In addition, a wide variety of polymer processing operations can be used in connection with the process. This allows a great number of product types to be prepared, including reinforced parts that contain a particulate and especially a fiber reinforcement.

The methods and products of the invention are based on PLA oligomers, which have hydroxyl, primary amino or secondary amino terminal groups or are capped to provide coreactive terminal groups. The PLA oligomers have at least one poly-D-PLA segment or at least one poly-L-PLA segment, each of which segments has a weight as low as about 350 and up to about 4800 daltons. A preferred weight for each of the lactic acid segments is from about 350 to about 2000 daltons. The poly-D-PLA or poly-L-PLA segments suitably constitute at least 60% of the total weight of the oligomers, preferably at least 75% by weight thereof.

A mixture of at least two such low molecular weight PLA oligomers is used in this invention. One of the oligomers is a poly-D-PLA oligomer. The other is a poly-L-PLA oligomer. The term “poly-D-PLA oligomer” refers to an oligomer containing at least one poly-D-PLA segment. A “poly-D-PLA” segment is a block of lactic acid repeating units, having a weight of from 350 to 4800 daltons, in which at least 90% are D-lactic acid units (the rest being L-lactic acid units). L-lactic acid repeating units constitute, on average, no more than 10 weight percent, preferably no more than 5 weight percent and even more preferably no more than 2 weight percent of the lactic acid repeating units in a poly-D-PLA segment. A poly-D-PLA segment may contain essentially no L-lactic acid repeating units. The poly-D-PLA segment or segments constitute at least 60% by weight of the poly-D-PLA oligomer. The poly-D-PLA oligomer does not contain poly-L-segments.

Similarly, the term “poly-L-PLA oligomer” refers to an oligomer containing L-at least one poly-L-PLA segment. A “poly-L-PLA” segment is a block of lactic acid repeating units, having a weight of from 350 to 4800 daltons, in which at least 90% are L-lactic acid units (the rest being D-lactic acid units). D-lactic acid repeating units constitute, on average, no more than 10 weight percent, preferably no more than 5 weight percent and even more preferably no more than 2 weight percent of the lactic acid repeating units in a poly-L-PLA segment A poly-L-PLA segment may contain essentially no D-lactic acid repeating units. The poly-L-PLA segment or segments constitute at least 60% by weight of the poly-L-PLA oligomer. The poly-L-PLA oligomer does not contain poly-D-PLA segments.

For the purposes of this invention, the terms “polylactide”, “polylactic acid” and “PLA” are used interchangeably to denote polymers or oligomers (as the case may be) having lactic acid repeating units. Lactic acid units are repeating units of the structure —OC(O)CH(CH₃)—. The poly-L-PLA oligomer and the poly-D-PLA oligomer are readily produced by polymerizing lactic acid or, more preferably, by polymerizing lactide. A particularly suitable process for preparing the poly-L-PLA oligomer and the poly-D-PLA oligomer by polymerizing lactide is described in U.S. Pat. Nos. 5,247,059, 5,258,488 and 5,274,073. This preferred polymerization process typically includes a devolatilization step during which the free lactide content of the polymer is reduced, preferably to less than 1% by weight, more preferably less than 0.5% by weight and especially less than 0.2% by weight. The polymerization catalyst is preferably deactivated.

Alternatively, the poly-L-PLA oligomer and the poly-D-PLA oligomer can be formed by polymerizing lactic acid.

The poly-L-PLA oligomer and the poly-D-PLA oligomer each have either (1) terminal hydroxyl, primary amino or secondary amino groups, or (2) terminal co-reactive groups, as defined before. Examples of coreactive groups are epoxide, carboxylic acid, carboxylic acid anhydride, carboxylic acid halide and isocyanate groups. The poly-L-PLA oligomer and the poly-D-PLA oligomer each contain, on average, at least 1.5 of such terminal groups per molecule. When a thermoplastic product is desired, the oligomers should contain approximately 2.0 hydroxyl or hydroxyl-reactive groups per molecule. If a thermoset product is desired, the oligomers can contain as many as 8 hydroxyl or hydroxyl-reactive groups per molecule, and preferably is from 2 to 6.

Hydroxyl terminal groups are introduced by conducting the polymerization in the presence of an initiator that contains hydroxyl and/or primary or secondary amino groups. As each lactide or lactic acid molecule adds to the initiator molecule and then to the polymer chain, a new hydroxyl group is formed at the chain end. The number of hydroxyl groups/molecule on the poly-L-PLA oligomer and the poly-D-PLA oligomer will be the same as or very close to the number of hydroxyl groups or amine hydrogen atoms per molecule on the initiator compound. Suitable such initiators include, for example, water; dialcohols such as ethylene glycol, propylene glycol, neopentyl glycol, 1,4-butanediol, 1,6-hexanediol, 1,8-octanediol, cyclohexanedimethanol and the like; glycol ethers such as diethylene glycol, triethylene glycol, dipropylene glycol, tripropylene glycol and the like, as well as higher oligomers of ethylene glycol and propylene glycol; compounds containing 3 or more hydroxyl groups such as glycerine, trimethylolpropane, pentaerythritol, sorbitol, sucrose, poly(vinyl alcohol), poly(hydroxyethylacrylate), poly(hydroxyethylmethacrylate) and the like; aminoalcohols such as monoethanolamine, diethanolamine, triethanolamine, monoisopropanolamine, diisopropanolamine, triisopropanolamine, aminoethylethanolamine, and the like; ammonia; and primary or secondary amines such as methylamine, ethylamine, piperazine, aminoethylpiperazine, toluene diamine, ethylene diamine, diethylenetriamine and the like. The initiator preferably has a molecular weight of not greater than 500, more preferably not greater than 250 and even more preferably not greater than 125.

Terminal amine groups can be introduced by converting terminal hydroxyl groups. This can be done by a reductive amination reaction with ammonia or a primary amine and hydrogen. Another way is to cap terminal hydroxyl groups with a polyisocyanate to introduce terminal isocyanate groups, and then hydrolyzing the terminal isocyanate groups to form amino groups. Suitable polyisocyanates for this capping reaction are as described below, with diisocyanates being preferred. Coreactive terminal groups are most conveniently introduced via a capping reaction.

Carboxyl terminal groups also can be introduced by capping the hydroxyl groups of a poly-L-PLA oligomer or the poly-D-PLA oligomer with a dicarboxylic acid or a dicarboxylic acid anhydride.

Epoxide terminal groups and isocyanate terminal groups are conveniently introduced to a hydroxyl-terminated poly-L-PLA oligomer or poly-D-PLA oligomer by capping with a polyepoxide or a polyisocyanate, respectively.

A wide range of polyepoxides can be used as a capping agent, including those described at column 2 line 66 to column 4 line 24 of U.S. Pat. No. 4,734,332, incorporated herein by reference. Suitable polyepoxides include the diglycidyl ethers of polyhydric phenol compounds such as resorcinol, catechol, hydroquinone, biphenol, bisphenol A, bisphenol AP (1,1-bis(4-hydroxylphenyl)-1-phenyl ethane), bisphenol F, bisphenol K, tetramethylbiphenol, diglycidyl ethers of aliphatic glycols and polyether glycols such as the diglycidyl ethers of C₂₋₂₄ alkylene glycols and poly(ethylene oxide) or poly(propylene oxide) glycols; polyglycidyl ethers of phenol-formaldehyde novolac resins, epoxy novolac resins, phenol-hydroxybenzaldehyde resins, cresol-hydroxybenzaldehyde resins, dicyclopentadiene-phenol resins and dicyclopentadiene-substituted phenol resins. Polyepoxides having a molecular weight of 500 or less, especially 400 or less, are especially preferred. Polyepoxides preferably contain 2 epoxy groups per molecule.

Polyisocyanates that are suitable as capping agents for introducing terminal isocyanate groups to the poly-L-PLA oligomer or poly-D-PLA oligomer, include m-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. The polyisocyanate preferably has a molecular weight of 300 or less.

The poly-L-PLA oligomer and the poly-D-PLA oligomer each are typically liquids or low-melting (Tₘ<60° C., preferably <50° C.) solids. They are useful for making high molecular weight block copolymers in a number of polymerization processes. A block copolymer is formed by linking the poly-L-oligomer and the poly-D-PLA oligomer together to form a high molecular weight chain. There two main approaches to accomplishing this.

In the first approach, one of the starting PLA oligomers has terminal hydroxyl, primary amino or secondary amino groups, and the other has terminal coreactive groups. The poly-L-PLA oligomer and the poly-D-PLA oligomer in this case can be mixed together and cured to form a high molecular weight polymer. An additional curing agent is not necessary, but may be used in some cases. In the absence of a curing agent, molecular weight is largely controlled by stoichiometry, with higher molecular weight polymers being formed as the ratio of coreactive groups supplied by one of the starting oligomers to hydroxyl, primary or secondary amino groups supplied by the other starting oligomer approaches 1:1. Ratios of the starting oligomers are preferably chosen such that the resulting polymer has a number average molecular weight of at least 25,000. The weight ratio of the poly-L-PLA segments to the poly-D-PLA segments provided by the respective oligomers is from about 20:80 to 80:20, more preferably from 30:70 to 70:30 and even more preferably from 40:60 to 60:40, so that the high molecular weight polymer can form high melting “stereocomplex” crystallites.

If both of the starting oligomers are difunctional (i.e., have 2 reactive terminal groups/molecule), the resulting high molecular weight polymer in most cases will be substantially linear and thermoplastic. If one or both of the starting oligomers have a greater functionality, the resulting high molecular weight polymer will be branched or even crosslinked.

If one PLA oligomer is hydroxyl-, primary amino or secondary amino-terminated and the other is terminated with coreactive groups, it still may be necessary or desirable to use an additional curing agent in making the block copolymer. This is typically the case when one PLA oligomer or the other is present in a stoichiometric excess, such that the mixture contains an excess of one type of terminal group or the other. A curing agent can in those cases be used to balance the stoichiometry, such that the number of hydroxyl or amino groups and coreactive groups is brought more closely into balance as needed to obtain the desired molecular weight. The curing agent can also be used in these cases to introduce crosslinking or branching. If the oligomers and the curing agent(s) are all difunctional, the resulting block copolymer in most cases will be linear and thermoplastic. If one or both of the oligomers and/or the curing agent have a greater functionality, the resulting block copolymer will be branched or crosslinked. In the second approach to forming the block copolymer, the terminal groups on the poly-L-PLA oligomer and the poly-D-PLA oligomer do not react with each other. Both of the oligomers may be hydroxyl-, primary amino- or secondary amino-terminated, or they may both be terminated with coreactive reactive groups. In this second approach, the block copolymer is formed by mixing the poly-L-PLA and poly-D-PLA oligomers together with a curing agent. The curing agent contains two or more groups that react with the terminal groups on the oligomers to couple the oligomers together and form the block copolymer. The proportions of the starting oligomers and the curing agent are selected to (1) produce a block copolymer having a number average molecular weight of at least 25,000 and (2) provide a weight ratio of poly-L-PLA segments to poly-D-PLA segments from about 20:80 to 80:20, more preferably from 30:70 to 70:30 and even more preferably from 40:60 to 60:40. Using this approach to form the block copolymer, the ratio of the number of equivalents of the two starting oligomers may vary significantly, provided that the stated weight ratios of poly-L-PLA segments to poly-D-PLA segments are present, as the curing agent will perform a chain-extension or crosslinking function and in that way helps to build molecular weight. Therefore, using this approach, the poly-D-PLA oligomer and the poly-L-oligomer may have significantly different molecular weights, if desired.

If the poly-L-PLA oligomer and the poly-D-PLA oligomer are both hydroxyl-, primary amino or secondary amino-terminated, then the curing agent is one which contains at least two coreactive groups per molecule. Suitable curing agents include polycarboxylic acids, carboxylic acid anhydrides, polyepoxides and polyisocyanates as described before, as well as other curing agents that can cure with hydroxyl, primary amino or secondary amino groups. As before, the formation of high molecular weight polymers is favored when the number of hydroxyl, primary amino or secondary amino groups supplied by the oligomers is approximately equal to the number of coreactive groups supplied by the curing agent(s). A ratio of hydroxyl-reactive groups to hydroxyl groups of from about 0.7:1 to 1.3:1 is generally suitable, a ratio of 0.85 to 1.15 is more preferred and a ratio of 0.95 to 1.05 is even more preferred. An exception to this is when the hydroxyl-reactive groups are isocyanate groups, which can trimerize under certain conditions (such as the presence of a trimerization catalyst) to form isocyanurate groups. For that reason, isocyanate groups can be present in large excess if it is desired to form isocyanurate linkages. If the oligomers and the curing agent(s) are all difunctional, the resulting block copolymer usually will be linear and thermoplastic. If one or both of the oligomers and/or the curing agent have a greater functionality, the resulting block copolymer will be branched or crosslinked.

If the poly-L-PLA oligomer and the poly-D-PLA oligomer are both terminated with coreactive groups, then the curing agent is one which contains at least two hydroxyl, primary amino or secondary amino groups per molecule. Suitable hydroxyl-containing curing agents include those polyhydroxyl compounds described before as initiators for producing hydroxyl terminated PLA oligomers. Suitable amine-containing curing agents include alkylene diamines such as ethylene diamine; aromatic diamines such as diethyltoluenediamine and phenylene diamine, polyalkylene polyamines, piperazine, aminoethylpiperazine, amine-terminated polyethers and the like. As before, the formation of high molecular weight polymers is favored when the number of hydroxyl and/or amino groups supplied by the curing agent(s) is approximately equal to the number of coreactive groups supplied by the oligomer(s). A ratio of coreactive groups to hydroxyl, primary amino or second amino groups of from about 0.8:1 to 1.5:1 is generally suitable, a ratio of 0.95 to 1.25 is more preferred and a ratio of 0.95 to 1.05 is even more preferred. As before, an exception to this is when the coreactive groups are isocyanates, which may be present in large excess if it is desired to introduce isocyanurate groups into the block copolymer. If the oligomers and the curing agent(s) are all difunctional, the resulting block copolymer in most cases will be linear and thermoplastic. If one or both of the oligomers and/or the curing agent have a greater functionality, the resulting block copolymer will be branched or crosslinked.

The curing reactions that form the block copolymer are all well-known types, and in general can be performed in ways that are known in the art. For example, the curing reaction results in the formation of a polyurethane when hydroxyl groups and isocyanate groups are present. Urea groups form when amino groups react with isocyanate groups. Ester groups are formed when hydroxyl groups cure with carboxylic acid groups. Amide groups form when amino groups react with carboxylic acid groups. Particular curing conditions will be selected depending on the particular curing reaction that is to take place.

Suitable conditions for forming polyurethanes and/or polyureas from isocyanates and hydroxyl- or amino-terminated precursors are well-known and described, for example, by Gum et al. in “Reaction Polymers: Chemistry, Technology, Applications, Markets”, Oxford University Press, New York (1992). The reaction conditions generally involve bringing the starting materials together, preferably in the presence of a urethane catalyst and optionally in the presence of applied heat. Suitable catalysts include tertiary amines, organometallic compounds, or mixtures thereof. Specific examples of these include di-n-butyl tin bis(mercaptoacetic acid isooctyl ester), dimethyltin dilaurate, dibutyltin dilaurate, dibutyltin diacetate, dibutyltin sulfide, stannous octoate, lead octoate, ferric acetylacetonate, bismuth carboxylates, triethylenediamine, N-methyl morpholine, like compounds and mixtures thereof. An organometallic catalyst can be employed in an amount from about 0.01 to about 0.5 parts per 100 parts of the reactants. A tertiary amine catalyst is suitably employed in an amount of from about 0.01 to about 3 parts per 100 parts by weight of the combined weight of the reactants.

Curing reactions between epoxide groups and hydroxyl or amino groups are also well known. Suitable conditions for effecting these cures are described, for example, in The Handbook of Epoxy Resins by H. Lee and K. Neville, published in 1967 by McGraw-Hill, New York. The curing reaction is usually performed in the presence of a catalyst, and heat can be applied to speed the cure. Suitable catalysts are described in, for example, U.S. Pat. Nos. 3,306,872, 3,341,580, 3,379,684, 3,477,990, 3,547,881, 3,637,590, 3,843,605, 3,948,855, 3,956,237, 4,048,141, 4,093,650, 4,131,633, 4,132,706, 4,171,420, 4,177,216, 4,302,574, 4,320,222, 4,358,578, 4,366,295. and 4,389,520, all incorporated herein by reference. Examples of suitable catalysts are imidazoles such as 2-methylimidazole; 2-ethyl-4-methylimidazole; 2-phenyl imidazole; tertiary amines such as triethylamine, tripropylamine and tributylamine; phosphonium salts such as ethyltriphenylphosphonium chloride, ethyltriphenylphosphonium bromide and ethyltriphenyl-phosphonium acetate; ammonium salts such as benzyltrimethylammonium chloride and benzyltrimethylammonium hydroxide; and mixtures thereof. The amount of the catalyst used generally ranges from about 0.001 to about 2 weight percent, and preferably from about 0.01 to about 1 weight percent, based on the total weight of the reactants used to make the block copolymer.

A curing reaction involving carboxyl groups and hydroxyl or amino groups is suitably conducted in the presence of an esterification catalyst and applied heat. Suitable catalysts include tin- or titanate-based polymerization catalysts including those described in U.S. Pat. Nos. 5,053,522, 5,498,651 and 5,547,984.

The product of the curing reaction is a block copolymer having multiple poly-D-PLA segments, each having a segment weight of from 350 to 4800, and multiple segments of a poly-L-PLA, each having a segment weight of from 350 to 4800. The poly-D-PLA segments and the poly-L-PLA segments are present in a weight ratio of from 20:80 to 80:20, preferably from 70:30 to 30:70 and more preferably from 60:40 to 40:60. The block copolymer has a number average molecular weight of at least 25,000.

The poly-D-PLA segments are linked to the poly-L-segments through some linkage that is not a direct bond between adjacent lactic acid repeating units. The linkages are typically derived from two different sources. The first source is the initiators that are used to make the starting oligomers. The starting oligomers in most cases will be diblock polymers having two polylactic acid segments that are joined by the residue of the initiator. This linkage is preserved in the final block copolymer. In some cases, the initiator will form a terminal group on a starting oligomer, and will further react with another oligomer molecule or curing agent when the block copolymer is formed, again forming all or part of a linkage between adjacent poly-PLA segments. The second source of linking groups is a capping agent or curing agent, a residue of which remains in the block copolymer and forms a linkage between adjacent poly-PLA segments when the block copolymer is formed. The second source can also be a linking group that is formed in the reaction of a hydroxyl group of a hydroxyl-terminated PLA oligomer and a hydroxyl-reactive group of hydroxyl-reactive group-terminated PLA oligomer.

Depending on the particular system, the order in which the poly-D-PLA segments and the poly-L-PLA segments are formed in the block copolymer may vary from a highly ordered A-B-A-B-type structure to a highly random ordering. The most highly ordered system is produced when one of the starting oligomers is hydroxyl-, primary amino or secondary amino-terminated and the other contains coreactive groups. In this case, the block copolymer usually has a highly ordered A-B-A-B type structure, especially when the starting oligomers are reacted together in the absence of a curing agent. When the starting oligomers both have hydroxyl-, primary amino or secondary amino terminal groups, or both have coreactive groups (being cured together with a curing agent in these cases), the block copolymer tends to have a more random arrangement of the poly-D-PLA segments and poly-L-PLA segments.

If the cured high molecular weight block copolymer is thermoplastic, it can be formed into pellets or other particles, which then can be used in subsequent melt-processing operations. The particulate block copolymer can then be melt-processed in the same manner as other thermoplastic materials, using methods such as extrusion, thermoforming, injection molding, compression molding, melt casting, extrusion coating, extrusion foaming, coating, bead foaming, pultrusion and the like.

It is also possible to produce a thermoplastic block copolymer as part of a process for making a finished article, such as, for example, a fiber, an injection molded article, an extruded product, a thermoformed part, a melt or extrusion coating, an expandable bead and the like. In such a case, a mixture of the poly-D-PLA oligomer and the poly-L-oligomer is subjected to conditions including an elevated temperature, such that they react to form a molten block copolymer, which is then processed into the finished article, without first cooling the block copolymer to below its melting temperature.

In processes such as extrusion, fiber spinning, thermoforming, compression molding, melt casting and pultrusion, the thermoplastic block copolymer is conveniently formed by mixing the starting oligomers (and curing agent, if any) in a single- or twin screw extruder, or other apparatus that permits for enough residence time to build a block copolymer having the necessary molecular weight. The molten block copolymer is then passed through a die (for extrusion, melt casting and pultrusion processes), spin pack (to produce fibers), or other apparatus to shape the melt and produce the product.

In molding processes, the block copolymer may be formed before oligomers (and any curing agent) are introduced into the mold. In this case, the starting materials are processed in an extruder or other apparatus as before, which provides sufficient residence time to build the necessary molecular weight. Alternately, starting materials can react in the mold to produce the block copolymer. It is also possible to conduct part of the polymerization after the article is removed from the mold. In the last case, the block copolymer should be at least partially formed before demolding, so that the molded article has enough strength to be demolded without damaging it.

Reaction injection molding and the various types of resin transfer or resin infusion molding processes are particularly suitable for producing molded parts. In the reaction injection molding (RIM) process, the starting materials are formulated into two components—one containing the reactants that have coreactive groups, and one containing the reactants that contain hydroxyl or amino groups. These components are combined, typically under high pressure impingement mixing conditions, and immediately transferred to the mold where they are cured. Heat may be applied to the mold if necessary to drive the cure. RIM processes are often used to make large parts or parts having high quality surfaces, such as automotive body panels, fascia or cladding. In RIM processes, the coreactive groups are preferably isocyanate groups. RIM processes are especially well-adapted for use with highly reactive mixtures that cure rapidly.

In resin transfer molding and resin infusion molding processes, the reaction mixture is formed and transferred into a mold that contains a fiber reinforcement preform. These processes tend to work best when the reaction mixture cures somewhat slowly, and so are especially suitable when the coreactive groups in the reaction mixture are epoxide groups. The reaction mixture enters the mold and flows between and around the fibers of the preform, filling essentially the entire void space of the mold, before curing to form a shaped composite.

Thermoset and thermoplastic high molecular weight block copolymers typically are simultaneously formed and made into finished or semi-finished articles. Because the starting oligomers tend to be liquids or low melting solids that have low to moderate melt viscosities, the invention is especially useful in connection with many methods that are used to process liquid starting materials to form thermosets. Examples of such methods include reactive extrusion, resin transfer molding, vacuum-assisted resin transfer molding, Seeman Composites resin infusion molding process (SCRIMP), reaction injection molding and casting, spray molding as well as other thermoset polymer processing techniques. The viscosities of the oligomers at the processing temperatures are low enough that they are easily processed on most commercial reaction injection molding or resin transfer molding equipment. The low viscosities also permit the reactants to flow easily around fibers or other particulate reinforcing agents, making the production of reinforced composites easy and economical.

High-temperature crystallinity is introduced to the block copolymer via a heat treatment, in which the block copolymer is heated to a temperature between its glass transition temperature and about 180° C. A preferred temperature for the heat treatment step is from 100 to 160° C., and a more preferred temperature is from 110 to 150° C. The heating is conducted for a period of time such that the high molecular weight polymer develops, per gram of polymer, at least 10 J of crystallites that have a crystalline melting temperature of at least 185° C. The crystallites preferably have a crystalline melting temperature of at least 195° C. or at least 200° C. These crystallites may have a melting temperature of up to about 235° C. These crystallites are believed to be associated with the formation of a stereocomplex of the high-D and high-L PLA resins. The polymer may, after heat-treatment, contain 25 J or more, 30 J or more, 35 J or more, or even 40 J or more of these high-melting crystallites per gram of high molecular weight polymer.

It may take from several seconds to several minutes of heating to develop this crystallinity, depending on the temperature that is used, the mass and dimensions of the part, and other factors.

The heat treatment step may also cause crystallites having a crystalline melting temperature of from about 140 to 175° C. to form. Crystallites of this type are believed to be structures formed by the crystallization of either the high-D PLA segments or the high-L PLA segments by themselves. The formation of these lower-melting crystallites is less preferred. Preferably, no more than 20 J of these crystallites are formed during the heat treatment step per gram of high molecular weight polymer. More preferably, no more than 15 J of these lower melting crystallites are formed, and even more preferably, no more than 10 J of these lower melting crystallites are formed per gram of polymer. In most preferred processes, from 0 to 5 J of the lower melting resin crystallites are formed in those segments, per gram of polymer.

The heat treatment step may be performed, before, at the same time, or after the block copolymer is processed into an article. Performing the heat treatment step before the article has been shaped has the disadvantage of requiring higher processing temperatures to be used, since it becomes necessary to heat the block copolymer to above the melting temperature of the high-melting crystallites in order to melt-process it. If the block copolymer is formed at a temperature which is also suitable for heat treating the polymer, crystallite formation may in some cases occur as the block copolymer is formed from the starting oligomers.

In most cases, however, the heat treatment step is performed in a downstream operation after the block copolymer has been shaped into an article. This can be due to processing limitations, a desire to obtain high production rates, or for other reasons. For example, in a fiber manufacturing process, the heat treatment step is generally performed after the fibers are spun and cooled to below their melting temperature. Extruded, melt-cast, and pultruded block copolymers typically are crystallized after the extrusion step.

In a molding process, the heat treatment step can be performed as part of the molding process while the block copolymer is in the mold.

The heat treatment step may be conducted during a post-curing operation, in which a partially-cured polymer is subjected to elevated temperatures to complete curing and further develop physical properties. An example of this is a molding processing, in which the starting oligomers are only partially cured in the mold before the part is demolded. Such partially-cured parts are then subjected to a post-curing operation, which can be combined with the heat-treatment step so that the curing is completed and the block copolymer is crystallized in a single operation

Various additives and materials can be included within the block copolymer, or used to produce the block copolymer.

One class of additives that is of particular interest includes reinforcements and fillers. Reinforcements are generally materials that do not melt or degrade at the processing temperatures, and which are in the form or particles or fibers that have an aspect ratio of greater than 2, preferably greater than 4. “Aspect ratio” refers to the ratio of the longest dimension of the particle or fiber divided by its shortest dimension. Fillers include particulate materials that do not melt or degrade at the processing temperatures, and which have an aspect ratio of 2 or less.

Reinforcements and fillers can be incorporated into the block copolymer in various ways. The method of choice in a particular case will depend somewhat on the manufacturing method used to make the block copolymer or a part from the block copolymer. When a molding process such as spray molding, resin transfer molding, resin infusion molding or reaction injection molding process is used, a fiber mat is often made and inserted into the mold before introducing the reaction mixture and curing it. In reaction injection molding process, short (6 inches or less, preferably 2 inches or less) fibers may be dispersed into one or the other of the starting components (or both), and introduced into the mold together with the reaction mixture.

Fillers can be added to the starting components or the uncured reaction mixture in many processing methods, including RIM, resin transfer molding, resin infusion molding, extrusion, among others. If desired, the filler can be added to the reaction mixture in the barrel of an extruder.

Other additives and materials that may be used include curing catalysts, including the types mentioned before; colorants; antioxidants, catalyst deactivators, stabilizers, surfactants, biocides, rubber particles, other organic polymers, tougheners, and the like.

A blowing agent may be incorporated into the block copolymer or the precursor materials, if it is desired to form a cellular polymer. Suitable blowing agents include physical types, which generate a gas by expansion or volatilization, or chemical types, which generate a gas via some chemical reaction. The blowing agent may be a gas at room temperature, such as air, nitrogen, argon or carbon dioxide. It may be a liquid at room temperature or a solid. Examples of physical blowing agents include water, hydrocarbons such as butane (any isomer), pentane (any isomer), cyclopentane, hexane (any isomer) or octane (any isomer); hydrofluorocarbons; hydrochlorocarbons; chlorofluorocarbons; chlorinated alkanes and the like. Chemical blowing agents include, for example, various types of compounds that decompose at elevated temperatures to release nitrogen or, less desirably, ammonia gas. Among these are so-called “azo” expanding agents, as well as certain hydrazide, semi-carbazides and nitroso compounds (many of which are exothermic types). Examples of these include azobisisobutyronitrile, azodicarbonamide, p-toluenesulfonyl hydrazide, oxybissulfohydrazide, 5-phenyl tetrazol, benzoylsulfohydroazide, p-toluolsulfonylsemicarbazide, 4,4′-oxybis(benzensulfonyl hydrazide) and the like.

Water is a blowing agent of particular interest when the block copolymer is formed from at least one starting material (a capped PLA oligomer or curing agent) that contains isocyanate groups. Water will react with two isocyanate groups to form a molecule of carbon dioxide and create a urea linkage. Its presence thus fulfills both a chain extension function and a blowing function. Thus, the process of the invention is amenable to making polyurethane foams in conventional processes such as slabstock and molded foam processes, when water is present in the formulation and isocyanate groups are available to react with the water.

It is also possible to form the high molecular weight block copolymer of the invention, and then infuse the block copolymer (especially in particulate form) with a blowing agent, thereby creating expandable polymer beads.

Catalysts are often useful to accelerate the cure of the starting oligomers to form the block copolymer. Catalysts for the reaction of an isocyanate with a hydroxyl, primary amino or secondary amino group include, for example, various organotin catalyst and tertiary amines. Catalysts for the reaction of an epoxide with a hydroxyl, primary amino or secondary amino group include p-chlorophenyl-N,N-dimethylurea, 3-phenyl-1,1-dimethylurea, 3,4-dichlorophenyl-N,N-dimethylurea, N-(3-chloro-4-methylphenyl)-N′,N′-dimethylurea (Chlortoluron), tert-acryl- or alkylene amines like benzyldimethylamine, 2,4,6-tris(dimethylaminomethyl)phenol, piperidine or derivates thereof, imidazole derivates, in general C₁-C₁₂ alkylene imidazole or N-arylimidazoles, such as 2-ethyl-2-methylimidazole, or N-butylimidazole, 6-caprolactam, and 2,4,6-tris(dimethylaminomethyl)phenol integrated into a poly(p-vinylphenol) matrix (as described in European patent EP 0 197 892) and aminoethyl piperazine. Tertiary amine catalysts are preferred. Suitable catalysts for the reaction of a carboxylic acid or carboxylic acid anhydride with a hydroxyl, primary amino or secondary amino group include various tin and titanium compounds.

The following examples are provided to illustrate the invention, but are not intended to limit the scope thereof. All parts and percentage are by weight unless otherwise indicated

### EXAMPLE 1

A 500-mL screw-cap Teflon vessel is charged with D-lactide (49.0 g, 0.34 mol) and ethylene glycol (1.0 g 0.016 mol). A tin-(II)-2-ethylhexanoate solution (142 μL of a solution of 1 g catalyst in 10 mL of toluene) is added to the mixture. The vessel is placed into a 180° C. oil bath for 4 hours. The product is poured into an aluminum pan and placed in a vacuum oven at 110° C. and 20 mm Hg for 16 hours. Upon cooling, the product poly-D-PLA oligomer forms an opaque white solid. Mₙ is approximately 3000 g/mol by NMR.

A poly-L-PLA oligomer is made in the same manner, substituting L-lactide for the D-lactide used before. The resulting material has an Mₙ of about 3150 g/mol by NMR.

A 250 mL round bottom flask is charged with the poly-L-PLA (10.0 g, 3.1 mmol), CHCl₃ (10 mL), and tin(II) 2-ethylhexanoate (100 μL, 0.24 mmol). 1,6-Hexamethylenediisocyanate (1.00 mL, 6.24 mmol) is added and the reaction mixture is heated under reflux for 16 hours. The poly-D-PLA oligomer (10.0 g, 3.1 mol) and tin(II) 2-ethylhexanoate (100 μL, 0.24 mmol) are added. The reaction is further refluxed for 2 hours. The reaction mixture is then poured into hexane (200 mL), in which the reaction product precipitates. The product is vacuum filtered to give a fluffy white powder that is dried in a vacuum oven at 110° C. and 20 mm Hg for 16 hours. The product is a block copolymer containing urethane groups and segments corresponding to each of the starting PLA oligomers. Mₙ is 28,400 by GPC. This block copolymer theoretically has an A-B-A-B arrangement of poly-D-PLA segments and poly-L-PLA segments.

Crystalline half-times are measured by DSC on a Mettler-Toledo DSC 822e device. The polymer sample is heated to 250° C. to melt out any existing crystallinity before rapidly cooling the sample to 130° C. and holding. Crystallinity is allowed to develop at 130° C. The sample is then heated at 20° C./min to 250° C. to melt out the crystallinity that has formed. Crystallization half-time is defined as the time necessary to develop half of the total crystallinity. The crystallization half-time is 2.1 minutes. The sample is found to contain 44.5 J/g of stereocomplex crystallinity having a Tₘ of 193° C. and 15.9 J/g of crystallinity having a Tₘ of 175.5° C.

### EXAMPLE 2

A 250 mL round bottom flask was charged with the poly-D-PLA and the poly-L-PLA prepared as in Example 1 (10.0 g, 3.1 mmoles of each), together with CHCl₃ (10 mL). Hexamethylenediisocyanate (1.00 mL, 6.24 mmol) is added and the reaction mixture is heated under reflux for 16 hours. The reaction mixture is then poured into hexane (200 mL) to cause the reaction product to precipitate. The product is vacuum filtered to give a fluffy white powder that is dried in a vacuum oven at 110° C. and 20 mm Hg for 16 hours. Mₙ is 27,900 by GPC.

Crystalline half-times are measured by DSC as before. The crystallization half-time is 4.4 minutes. The sample is found to contain 37 J/g of stereocomplex crystallinity having a Tₘ of 189° C. and 13.8 J/g of crystallinity having a Tₘ of 168° C.

This block copolymer has a more random arrangement of the poly-D-PLA segments and the poly-L-PLA segments than does the copolymer of Example 1. This is believed to at least partially account for the longer crystallization half-time and the lower stereocomplex crystalline melting temperature that is seen in this copolymer.

It will be appreciated that many modifications can be made to the invention as described herein without departing from the spirit of the invention, the scope of which is defined by the appended claims.

1. A block copolymer having a number average molecular weight of at least 25,000, the block copolymer having multiple segments of a poly-D-PLA, each having a segment weight of from 350 to 4800, and multiple segments of a poly-L-PLA, each having a segment weight of from 350 to 4800, wherein the poly-D-PLA segments and the poly-L-PLA segments are present in a weight ratio of from 20:80 to 80:20 and are linked through linking groups other than direct bonds between adjacent lactic acid units.

2. The block copolymer of claim 1 wherein the linking groups other than direct bonds between adjacent lactic acid units include residues of initiator compounds used to prepare a poly-D-PLA oligomer and to prepare a poly-L-oligomer, and at least one of a) a residue of a curing agent and b) a linking group that is formed in the reaction of a hydroxyl-, primary amino-, or secondary amino-group of a hydroxyl, primary amino- or secondary amino-terminated PLA oligomer and a coreactive group of coreactive group-terminated PLA oligomer.

3. The block copolymer of claim 2 that contains at least 10 μg of crystallites having a melting temperature of at least 185° C.

4-5. (canceled)

6. The block copolymer of claim 2 which contains urethane groups.

7. The block copolymer of claim 2 which contains urea groups.

8. The block copolymer of claim 2 which contains ester groups.

9. A process for making a high molecular weight block copolymer, comprising
I. forming a mixture of
a) a hydroxyl-, primary amine- or secondary amine-terminated PLA oligomer having at least one segment of repeating lactic acid units that has a weight of from 350 to 4800 daltons and which constitutes at least 60 weight percent of the oligomer and
b) a capped PLA oligomer having terminal coreactive groups and having at least one segment of repeating lactic acid units that has a weight of from 350 to 4800 daltons and which constitutes at least 60 weight percent of the oligomer; wherein the segment or segments of repeating lactic acid units in one of the PLA oligomers is a poly-D-PLA segment and the segment or segments of repeating lactic acid units in the other PLA oligomer is a poly-L-PLA segment, and
II. curing the mixture to form a high molecular weight block copolymer having multiple segments of a poly-D-PLA that each has a weight of from 350 to 4800 daltons and multiple segments of a poly-L-PLA that each has a weight of from 350 to 4800 daltons.

10. The process of claim 9, wherein the capped PLA oligomer contains terminal carboxylic acid, epoxide, carboxylic acid anhydride or carboxylic acid halide groups.

11. The process of claim 9, wherein the capped PLA oligomer contains terminal isocyanate groups.

12. The process of claim 9, further comprising:
III. heat treating the high molecular weight block copolymer at a temperature between its glass transition temperature and about 180° C. to form at least 10 J/g of crystallites having a melting temperature of at least 185° C.

13. The process of claim 12 wherein after step III the block copolymer contains at least 20 J/g of crystallites having a melting temperature of at least 185° C.

14. (canceled)

15. A process for making a block copolymer, comprising
I. forming a mixture of
a) a hydroxyl-, primary amine- or secondary amine-terminated poly-D-PLA oligomer having at least one poly-D-PLA segment that has a weight of from 350 to 4800 daltons and which constitutes at least 60 weight percent of the poly-D-PLA oligomer,
b) a hydroxyl-, primary amine- or secondary amine-terminated poly-L-PLA oligomer having at least one poly-L-PLA segment that has a weight of from 350 to 4800 daltons and which constitutes at least 60 weight percent of the poly-L-PLA oligomer and
c) at least one curing agent that contains at least two coreactive groups per molecule and
II. curing the mixture to form a high molecular weight block copolymer.

16. The process of claim 15, wherein the curing agent contains terminal carboxylic acid, epoxide, carboxylic acid anhydride or carboxylic acid halide groups.

17. The process of claim 15, wherein the curing agent contains terminal isocyanate groups.

18. The process of claim 15, further comprising:
III. heat treating the high molecular weight block copolymer at a temperature above its glass transition temperature to about 180° C. to form at least 10 J/g of crystallites having a melting temperature of at least 185° C.

19-20. (canceled)

21. A process for making a high molecular weight block copolymer, comprising
I. forming a mixture of
a) a poly-D-PLA oligomer which is terminated with coreactive groups and has at least poly-D-PLA segment that has a weight of from 350 to 4800 daltons and constitutes at least 60% by weight of the poly-D-PLA oligomer, and,
b) a poly-L-PLA oligomer which is terminated with coreactive groups having at least one poly-D-PLA segment that has a weight of from 350 to 4800 daltons and constitutes at least 60% by weight of the poly-L-PLA oligomer, and
c) at least one curing agent that contains at least two hydroxyl, primary amino or secondary amino groups per molecule, and
II. curing the mixture to form a high molecular weight block copolymer.

22. The process of claim 21, wherein the poly-D-PLA oligomer and the poly-L-PLA oligomer each contains terminal carboxylic acid, epoxide, carboxylic acid anhydride or carboxylic acid halide groups.

23. The process of claim 21, wherein the poly-D-PLA oligomer and the poly-L-PLA oligomer each contains terminal isocyanate groups.

24. The process of claim 21, further comprising:
III. heat treating the high molecular weight block copolymer at a temperature above its glass transition temperature to about 180° C. to form at least 10 J/g of crystallites having a melting temperature of at least 185° C.

25-30. (canceled)

31. A capped, linear PLA resin having terminal coreactive groups and at least one segment of repeating D-lactic acid units or repeating L-lactic acid units that has a weight of from 350 to 4800 daltons.
